(19) United States
(12) Patent Application Publication
(10) Pub. No.: US 2024/0102640 A1
(43) Pub. Date: Mar. 28, 2024

(54) ORIENTABLE LUMINAIRE HEAD, FIXATION ASSEMBLY THEREFOR, AND METHOD FOR ADJUSTING AN ORIENTATION THEREOF

(71) Applicant: SCHREDER S.A., Bruxelles (BE)

(72) Inventors: Ferenc LÁMFALUSI, Pilisszentiván (HU); Péter BUDAVÁRI, Pilisszentiván (HU); Zoltán JANKI, Pilisszentiván (HU); Csaba HORVÁTH, Pilisszentiván (HU)

(21) Appl. No.: 18/257,154

(22) PCT Filed: Dec. 15, 2021
(86) PCT No.: PCT/EP2021/085862

§ 371 Date: Jun. 13, 2023

(30) Foreign Application Priority Data
Dec. 15, 2020 (NL) 2027117

(51) Int. Cl. F21V 21/30; F21S 8/08

(52) U.S. Cl. CPC F21V 21/30; F21S 8/086; F21Y 2115/10

(57) ABSTRACT

A luminaire head (12) for a luminaire (1), preferably an outdoor luminaire, said luminaire head (12) comprising: a light module (121) provided with a light source (1211); a gear module (122) provided with a light source driving means; and a fixation assembly (10) configured to connect the luminaire head (12) to a luminaire support, such as a luminaire pole (11), and to adjust an orientation of at least the light module (121); wherein a first portion of the luminaire head (12) comprising at least the fixation assembly (10) extends over a distance of at least 25% of a length (LI) of the luminaire head (12), and a second portion of the luminaire head (12) comprising at least the light module (121) is configured to be rotated with respect to said first portion around a rotation axis (A); wherein the fixation assembly (10) is configured to fix the light module (121) in a plurality of fixing positions (P1, P2, P3).

### FIELD OF INVENTION

The present invention relates to luminaire heads and methods. Particular embodiments relate to an orientable luminaire head and a method for adjusting the orientation of a luminaire head.

### BACKGROUND

In the commonly used outdoor luminaires, the luminaire head angle, defined as the angle between the luminaire head and the end of a pole connecting said luminaire head, is fixed, or is inconvenient to adjust. Therefore, the light distribution of the outdoor luminaire is not adequately adjustable according to the characteristics of the environment to be lighted, such as the width of a road. Hence, it is necessary to manufacture outdoor luminaires of different inclinations corresponding to different luminaire head angles, according e.g. to the width of different road surfaces, thereby increasing the manufacturing costs.

Generally, a luminaire head can be fixed to a pole end following two main configurations. The first configuration corresponds to a pole end oriented in a substantially vertical direction, referred to as “post-top” configuration in the following. The second configuration corresponds to a pole end oriented in a substantially horizontal direction, referred to as “side-entry” configuration in the following. The current problem occurring in the industry of outdoor luminaires is that luminaire heads are designed either to be fixed according to the post-top configuration, or according to the side-entry configuration, thereby also increasing the manufacturing costs.

WO2019229045A1 in the name of the Applicant discloses an angle adjustment and rotation system which allows for a luminaire head to be adjusted with ease to a variety of different orientations while still allowing for a high degree of precision, and which is not unnecessarily complex. The angle adjustment and rotation system comprises a first element, a second element, and an attaching element. The attaching element, which attaches the first element to the second element, is configured to have at least a first state in which it tightly attaches the first element to the second element and a second state in which it movably attaches the first element to the second element.

Other existing systems for tilting a luminaire head are described in international patent application WO2020144191 and in Dutch patent application NL2026604 in the name of the Applicant.

Although the above systems provide a good and robust solution for adjustably attaching a luminaire head to a support such as a pole, for some applications it is advantageous to look for alternative or additional systems.

### SUMMARY

An object of embodiments of the invention is to provide a fixation assembly for use in a luminaire head. More in particular, embodiments of the invention aim at providing a luminaire head for which the rotation angle can be adjusted on site, depending on the site to be illuminated and/or the specific application. In addition, embodiments of the invention provide a fixation assembly for use in such a luminaire head. Embodiments of the invention also provide a method for adjusting an orientation of a luminaire head connected to a luminaire support, such as a luminaire pole, with such a fixation assembly.

According to a first aspect of the invention, there is provided a luminaire head for a luminaire, preferably an outdoor luminaire. Said luminaire head comprises a light module provided with a light source, a gear module provided with a light source driving means, and a fixation assembly configured to connect the luminaire head to a luminaire support, such as a luminaire pole, and to adjust an orientation of at least the light module. A first portion of the luminaire head comprising at least the fixation assembly extends over a distance of at least 25% of a length of the luminaire head, and a second portion of the luminaire head comprising at least the light module is configured to be rotated with respect to said first portion around a rotation axis. The fixation assembly is configured to fix the light module in a plurality of fixing positions.

Embodiments of the invention are based inter alia on the insight that the light distribution of common outdoor luminaires is not adequately adjustable according to the characteristics of the environment to be lighted, such as the width of a road. Moreover, in the commonly used outdoor luminaires, the luminaire head angle may be inconvenient to adjust in the case the entire luminaire head, i.e., the luminaire head housing and all its components, may be orientable with respect to the luminaire pole. This may result in orientable luminaire heads that may be significantly heavy, thereby leading to a difficult and unstable mounting thereof on e.g. a luminaire pole for the operator or user on site. Also, the structure of the luminaire that supports a heavy orientable luminaire head may be damaged.

In the luminaire head of embodiments of the invention, the fixation assembly is configured to connect the luminaire head to the luminaire support, such as a luminaire pole, and to adjust an orientation of at least the light module. Therefore, at least the light module may be orientable with respect to the first portion of the luminaire head, and hence with respect to the luminaire pole.

Moreover, in the luminaire head of embodiments of the invention the first portion of the luminaire head comprising at least the fixation assembly extends over a distance of at least 25% of a length of the luminaire head, and the second portion of the luminaire head comprising at least the light module is configured to be rotated with respect to said first portion around a rotation axis. In an embodiment, the first portion may be fixed to the luminaire support, such as a luminaire pole, in a single position, or in an alternative embodiment in a plurality of positions, such that the first portion itself may be orientable with respect to the luminaire support, independently from the orientation of the second portion with respect to the first portion around said rotation axis.

Therefore, the fixation of the luminaire head to the luminaire support is facilitated, whilst a robust, stable, and adjustable fixation of the luminaire head is enabled in a plurality of fixing positions corresponding to different inclinations of the luminaire head. Indeed, said first portion of the luminaire head extends over a sufficiently large fraction of the length of the luminaire head. Hence, the mounting of the luminaire head on the luminaire support is improved, as the free length of the luminaire head, i.e., the remaining length of the luminaire head that is not fixed, is reduced, thereby enabling a more stable mounting of the luminaire head, especially if it is significantly heavy. In the context of the invention, the term “plurality of fixing positions” should be construed as a number of discrete physical positions wherein at least the light module is fixed to the first portion comprising at least the fixation assembly. By “discrete physical positions”, it is meant a finite number of fixing positions differentiable from one another and physically provided to the first portion, especially to the fixation assembly, and/or to at least the light module. The above construction should be opposed to an infinite number of virtual positions wherein at least a light module may be oriented with respect to a fixed part of the luminaire head such as said first portion. With this respect, relatively heavy luminaire heads may be orientable and fixed in a secure manner by rotating at least the light module around the rotation axis, because the torque, or moment of force, of the luminaire head may be reduced thanks to the above reduction of its free length. Therefore, the risk that the supporting structure, i.e., the fixation assembly, of the luminaire that supports a relatively heavy orientable luminaire head be damaged may be reduced.

Preferred embodiments relate to a luminaire head for an outdoor luminaire By outdoor luminaire, it is meant luminaires which are installed on roads, tunnels, industrial plants, stadiums, airports, harbors, rail stations, campuses, parks, cycle paths, pedestrian paths or in pedestrian zones, for example, and which can be used notably for the lighting of an outdoor area, such as roads and residential areas in the public domain, private parking areas, access roads to private building infrastructures, warehouses, industry halls, etc.

According to an exemplary embodiment, a distance between the rotation axis and the luminaire support is at least 25% of the length of the luminaire head, preferably at least 40% of said length.

In this way, the free length of the luminaire head is reduced, which in turn reduces the torque of the luminaire head, thereby enabling a more stable mounting of the luminaire head on the support.

According to an exemplary embodiment, a distance between the rotation axis and the plurality of fixing positions is at least 25% of the length of the luminaire head, preferably at least 40% of said length.

In this way, the length of the fixation assembly may correspond to a sufficiently large fraction of the length of the luminaire head. Hence, the mounting of the luminaire head on the luminaire support is improved, as explained above. This may be especially advantageous if both the light module and the gear module may be orientable with respect to the fixation assembly.

According to an exemplary embodiment, a length of the fixation assembly is at most 75% of the length of the luminaire head. According to an alternative exemplary embodiment, a length of the fixation assembly is substantially equal to the length of the luminaire head.

In other words, according to a first exemplary embodiment the length of the fixation assembly need not correspond to a length comparable to that of the luminaire head, although it may correspond to a sufficiently large fraction of said length. For example, the length of the fixation assembly may correspond to 50-60% of the length of the luminaire head. However, according to a second and alternative exemplary embodiment the length of the fixation assembly may correspond to a length substantially equal to that of the luminaire head. In some embodiments, said lengths may be equal.

According to a preferred embodiment, the fixation assembly has a first end nearest to the luminaire support and a second end opposite said first end. One of the rotation axis and the plurality of fixing positions is arranged at said first end, and the other one of the rotation axis and the plurality of fixing positions is arranged at said second end.

In other words, according to a first embodiment the rotation axis may be arranged at a distance from the luminaire support, e.g. at a distance corresponding to at least 25% of the length of the luminaire head, preferably at least 40% of said length, as described above. However, according to a second and alternative embodiment the rotation axis may be arranged nearest the luminaire support. In this case, the plurality of fixing positions may be arranged at a distance from the luminaire support, e.g. at a distance corresponding to at least 25% of the length of the luminaire head, preferably at least 40% of said length.

According to a preferred embodiment, the rotation axis and the plurality of fixing positions are configured to adjust a position of at least the light module relative to the fixation assembly over an angle of 15°, preferably over an angle of 30°. According to an exemplary embodiment, two adjacent positions of the plurality of fixing positions are configured to adjust a position of at least the light module relative to the fixation assembly over an angle between 2° and 15°.

Hence, a fine adjustment of the angle of the luminaire head is enabled over a sufficiently large angular range, thereby providing a luminaire head for which the rotation angle can be conveniently adjusted on site, depending on the site to be illuminated and/or the specific application and/or the characteristics of the environment to be lighted, such as the width of a road. It is noted that these embodiments are in line with the above construction of the term “plurality of fixing positions”.

According to an exemplary embodiment, the first portion of the luminaire head corresponds to the fixation assembly and the gear module. The gear module is configured to be attached to the fixation assembly in a fixed position, and the light module is configured to be rotated with respect to the fixation assembly and the gear module. Preferably, the light module delimits a first sealed compartment and the gear module delimits a second sealed compartment.

In other words, in this exemplary embodiment only the light module may be orientable with respect to the fixation assembly and the gear module, and thus independently from the gear module that remains in a fixed position with respect to said fixation assembly since the gear module is attached to the fixation assembly. This exemplary embodiment may be particularly advantageous when the total weight of the luminaire head, i.e., the summed weight of the light module and of the gear module, may be significantly high. In this case, it is preferable that the light module and the gear module correspond to individual sealed compartments that are independent from each other.

According to an embodiment wherein only the light module is orientable with respect to the fixation assembly and the gear module, the gear module may comprise an image capturing means, such as a camera. In this way, a field of view (FOV) of the image capturing means may remain the same, and thus may not be perturbed by the orientation of the light module with respect to the fixation assembly. The gear module may additionally or alternatively comprise other sensing and/or communication and/or projecting means, such as antennas, environmental sensors such as light sensors, projectors, presence or movement sensors, sound sensor, microphone, whose emitting/receiving area (e.g. directionality of an antenna) or sensing area such as FOV may remain the same, independently from any orientation of the light module with respect to the fixation assembly. This may be advantageous in applications wherein the FOV of e.g. a camera is independent from the main emission direction of the light source, such as in systems wherein the FOV of the camera must be kept in direction of a single area of interest whereas the light source may be oriented so as to illuminate different areas. In another applications, the directionality of an antenna must remain constant so as to optimize the reception quality of signals whereas the light source may be oriented so as to illuminate different areas.

According to an alternative exemplary embodiment, the first portion of the luminaire head corresponds to the fixation assembly. The gear module is configured to be attached to the light module in a fixed position, and the light module and the gear module are configured to be rotated with respect to the fixation assembly. Preferably, the light module and the gear module delimit together a single sealed compartment.

In other words, in this alternative exemplary embodiment the light module and the gear module may together be orientable with respect to the fixation assembly, since the gear module is attached to the light module. In this case, it is preferable that the light module and the gear module correspond to a single sealed compartment, although in other embodiments, they may correspond to individual sealed compartments that are independent from each other.

According to an embodiment wherein the light module and the gear module are together orientable with respect to the fixation assembly, the gear module may comprise an image capturing means, such as a camera. In this way, an FOV of the image capturing means may be modified, and thus may be adjusted thanks to the joint orientation of the light module and the gear module with respect to the fixation assembly. The gear module may additionally or alternatively comprise other sensing and/or communication and/or projecting means, such as antennas, environmental sensors such as light sensors, projectors, presence or movement sensors, sound sensor, microphone, whose emitting/receiving area (e.g. directionality of an antenna) or sensing area such as FOV may be adjusted thanks to the joint orientation of the light module and the gear module with respect to the fixation assembly. This may be advantageous in applications wherein the FOV of e.g. a camera is linked to the main emission direction of the light source, such as in surveillance systems wherein the light source may be oriented in the same direction as the camera for improving the quality of images captured by the surveillance camera.

According to an exemplary embodiment, the light module comprises a rotatable support comprising a front portion and a rear portion. The light source is arranged in the front portion, and the rear portion is provided with at least one fixation bracket arranged between the fixation assembly and one side of the gear module and configured to be fixed to the fixation assembly. Preferably, the rear portion is provided with two fixation brackets arranged between the fixation assembly and either side of the gear module and configured to be fixed to the fixation assembly.

According to another exemplary embodiment, the light module comprises a rotatable support comprising a front portion and a rear portion. The light source is arranged in the front portion, and the rear portion is provided with a cover configured to cover the gear module.

The provision of at least one fixation bracket arranged between the fixation assembly and one side of the gear module may be especially advantageous if only the light module may be orientable with respect to the fixation assembly, so that the rotation movement of the light module is not hindered by the presence of the fixed gear module. In another embodiment, a minimal distance between the fixed gear module and the orientable light module may be provided, so that the rotation movement of the light module is not hindered by the presence of the fixed gear module. Thus, the rear portion of the rotatable support may be provided with a cover configured to cover the gear module without hindering the rotation movement of the light module. By contrast, if both the light module and the gear module are orientable with respect to the fixation assembly, the rotation movement of the light module would not be hindered by the presence of the gear module, since both modules are attached to each other and rotate together. Thus, the rear portion of the rotatable support may be provided with a cover configured to cover the gear module without hindering the rotation movement of the light module.

According to an alternative exemplary embodiment, the light module comprises a rotatable support at a front side of the luminaire head whereon the light source is arranged, and the gear module comprises a fixed support at a rear side of the luminaire head whereon the light source driving means is arranged. Seen in plane parallel to said rotatable support and to said fixed support, there is no overlap between the rotatable support and the fixed support.

In other words, in this alternative embodiment only the light module may be orientable with respect to the fixation assembly, the electrical/electronic components of the gear module being fixed on said fixed support. Seen in the above-mentioned plane, the absence of overlap between the rotatable support and the fixed support ensures that the rotation movement of the light module is not hindered by the presence of the fixed gear module.

According to an exemplary embodiment, the fixation assembly comprises a front portion at the front side of the luminaire head and configured to receive the light module, and a rear portion at the rear side of the luminaire head and configured to receive the gear module.

In this way, the light module comprising the light source may be arranged at the front of the luminaire head in order to illuminate its environment in an efficient way, and the gear module comprising the electrical/electronic components may be arranged at the rear of the luminaire head.

According to a preferred embodiment, the fixation assembly comprises two side wings, each intersecting the rotation axis. At least the light module is configured to be fixed to the two side wings in the plurality of fixing positions and the gear module is at least partially arranged between the two side wings.

According to an exemplary embodiment, a length of the two side wings is at most 75% of the length of the luminaire head. According to an alternative exemplary embodiment, a length of the two side wings is substantially equal to the length of the luminaire head.

According to a preferred embodiment, the fixation assembly comprises a first fixation element configured to be attached to the luminaire head and a second fixation element configured to receive and be attached to the luminaire support and to cooperate with the first fixation element.

In this way, the fixation assembly may also play the role of a pole adaptor through the provision of said second fixation element. For example, the second fixation element of the fixation assembly may enable the connection of poles having different dimensions to the luminaire head, so that the connection between the luminaire head and the pole is convenient to adjust. Therefore, the installation of the luminaire head can be adequately adjustable according to the characteristics of the pole to be connected, such as its diameter, thereby decreasing the manufacturing costs.

According to an exemplary embodiment, the second fixation element is configured to be fastened to the first fixation element in a first configuration and in a second configuration. The first fixation element and the second fixation element are substantially perpendicular in the first configuration and substantially parallel in the second configuration.

The first configuration may be referred to as “post-top” configuration of the luminaire head, wherein the luminaire pole end is oriented in a substantially vertical direction, whereas the second configuration may be referred to as “side-entry” configuration of the luminaire head, wherein the luminaire pole end is oriented in a substantially horizontal direction. In this way, the configuration and arrangement of the first and second fixation elements enable a fixation of the luminaire head relative to the luminaire pole according to both post-top and side-entry configurations.

According to an exemplary embodiment, the first fixation element comprises two side wings and an inclined base wall connecting the two side wings, and the second fixation element comprises a tubular wall and an inclined base wall configured to match the inclined base wall of the first element fixation in said first configuration and second configuration. Preferably, the inclined base wall of the first fixation element is inclined at an angle of 45° with respect to a plane perpendicular to the two side wings. Preferably, the inclined base wall of the second fixation element is inclined at an angle of 45° with respect to the plane perpendicular to the two side wings, in order to match the inclined base wall of the first fixation element.

In this way, in order to move from the above first configuration to the above second configuration, and vice versa, the second element may be pivoted by an angle of 180° with respect to the first element. The inclined base wall of the first fixation at said angle of 45° enables said rotation movement. Hence, enabling a rotation of the second fixation element with respect to the first fixation element by an angle of 180° corresponds to enabling the use of a single fixation assembly for both post-top and side-entry configurations, thereby reducing manufacturing costs.

According to an exemplary embodiment, the inclined base wall of the second fixation element is provided with a threaded portion protruding through the inclined base wall of the first fixation element, and the inclined base wall of the first fixation element is provided with a nut matching the threaded portion. Preferably, said threaded portion is provided with a hole configured to receive a cable extending between the luminaire support and the luminaire head.

In this way, a robust yet removable fastening of the first fixation element to the second fixation element is enabled. The second fixation element may be unfastened from the first fixation element, rotated by 180°, and fastened again to the first fixation element according to one of the first and second configurations. Also, the provision of said hole to the threaded portion enables an electrical connection between the luminaire support and the luminaire head, such as the provision of power from the mains. A gasket may be arranged in said hole, in order to ensure a sealed electrical connection protected against dust and water, e.g. an IP66 or IP67 sealed electrical connection.

According to a preferred embodiment, the light source comprises a support, such as a PCB, on which a plurality of light emitting diodes (LEDs) is mounted. The LEDs may be arranged in an array of multiple columns and rows.

According to a preferred embodiment, the luminaire head is provided with a heat sink including a plurality of cooling fins. A heat sink enables dissipation of heat generated by the light source towards the outside of the luminaire head.

According to a preferred embodiment, one or more optical elements are associated with the light source. The one or more optical elements may comprise a plurality of lens elements associated with the plurality of LEDs, e.g. grouped in a lens plate. However, also other types of optical elements may be additionally or alternatively present, such as reflectors, backlights, prisms, collimators, diffusors, and the like. In the context of the invention, a lens element may include any transmissive optical element that focuses or disperses light by means of refraction. It may also include any one of the following: a reflective portion, a backlight portion, a prismatic portion, a collimator portion, a diffusor portion. For example, a lens element may have a lens portion with a concave or convex surface facing a LED, or more generally a lens portion with a flat or curved surface facing the LED, and optionally a collimator portion integrally formed with said lens portion, said collimator portion being configured for collimating light transmitted through said lens portion. Also, a lens element may be provided with a reflective portion or surface or with a diffusive portion.

According to an exemplary embodiment, the light source may comprise a plurality of first light elements such as LEDs and one or more associated first optical elements configured to output a first light beam having a first color temperature according to a first intensity distribution within a first solid angle, and a plurality of second light elements such as LEDs and one or more associated second optical elements configured to output a second light beam having a second color temperature according to a second intensity distribution within a second solid angle. The second intensity distribution may be different from the first intensity distribution. Also, the second color temperature may be different from the first color temperature. Exemplary embodiments of such light sources are disclosed in Dutch patent application with application number NL2024571 in the name of the applicant which in included herein by reference.

According to an exemplary embodiment, the light source may comprise RGB and/or RGBW and/or RGBA LEDs and associated control circuitry for controlling the color emitted by the light source.

According to an exemplary embodiment, the luminaire head, in particular the light module, further comprises a transparent or translucent portion facing the light source. Optionally, a color filter arranged between the light source and the transparent or translucent portion. For example, the color filter may be a sheet arranged above the transparent or translucent portion. The color filter is configured to absorb a portion of the light emitted by the light source in specific wavelength ranges so as to change the color of the light emitted by the luminaire head. Preferably, the color filter is accessible by opening the luminaire head, in particular the light module. In that way, the color filter can be easily changed, e.g. when it is desirable to change the color of the emitted light for a special occasion or festivity.

According to a preferred embodiment, the gear module comprises any one or more of the following: a light source dimming means, surge protection circuitry, electrostatic discharge (ESD) protection circuitry, connecting means, a fuse, a metering circuitry, a driving and/or control circuitry for any electrical components of the luminaire head.

Surge protection circuitry is provided to absorb energy and protect the driver, typically including a LED driver circuit, and optionally a light source dimming means. The role of an ESD protection circuitry is to reduce the risk of accumulating electrostatic charge to a critical level so as to avoid that ESD happen through an insulation layer and damage semiconductor components such as LEDs. Optionally, a flux exhauster may be arranged at a side of the luminaire head, around the light source. In addition or alternatively, an inner surface of said side may be painted or coated to fulfill the function of flux exhauster itself. A flux exhauster in the context of the present invention is typically plate-like and has a surface with good reflective properties.

According to embodiments of the invention, the luminaire head comprises a housing wherein the light source, the electrical/electronic components, and optionally the heat sink and flux exhauster are arranged. The above-mentioned transparent or translucent portion facing the light source may be part of the housing. Also, the housing may comprise an upper cover configured to cover and protect the components of the luminaire head inside the housing. Preferably, the transparent or translucent portion and the upper cover form a sealed housing. In some embodiments, the luminaire head can have an overall round shape, i.e., any one or more of the components of the luminaire head may have a round shape. In other embodiments, the luminaire head may have an overall polygonal shape, such as a square or rectangular shape. Thus, any one or more of the components of the luminaire head may have a polygonal shape. Also mixed shapes are possible.

According to a second aspect of the invention, there is provided a fixation assembly for use in the luminaire head of any one of the previous embodiments. The fixation assembly is configured to connect the luminaire head to the luminaire support and to adjust the orientation of at least the light module. A first portion of the luminaire head comprising at least the fixation assembly extends over a distance of at least 25% of a length of the luminaire head, and a second portion of the luminaire head comprising at least the light module is configured to be rotated with respect to said first portion around a rotation axis. The fixation assembly is configured to fix the light module in a plurality of fixing positions.

The skilled person will understand that the hereinabove described technical considerations and advantages for the luminaire head embodiments of the first aspect also apply to the corresponding fixation assembly embodiments of the second aspect, mutatis mutandis.

According to a third aspect of the invention, there is provided a method for adjusting an orientation of a luminaire head connected to a luminaire support, such as a luminaire pole, with the fixation assembly of the second aspect. Said luminaire head comprises a light module provided with a light source and a gear module provided with a light source driving means. Said method comprises rotating at least the light module relative to the fixation assembly around the rotation axis in order to control the orientation of at least the light module and fixing the light module to the fixation assembly in a plurality of fixing positions.

The skilled person will understand that the hereinabove described technical considerations and advantages for the luminaire head embodiments of the first aspect also apply to the corresponding method embodiments of the third aspect, mutatis mutandis.

### BRIEF DESCRIPTION OF THE FIGURES

This and other aspects of the present invention will now be described in more detail, with reference to the appended drawings showing a currently preferred embodiment of the invention. Like numbers refer to like features throughout the drawings.

FIGS. 1A-1F are perspective views of an exemplary embodiment of a luminaire head;

FIGS. 2A-2F are perspective views of another exemplary embodiment of a luminaire head;

FIGS. 3A-3E are perspective views of yet another exemplary embodiment of a luminaire head;

FIGS. 4A and 4B show two different exemplary embodiments of a luminaire head according to two different fixation configurations to a luminaire support; and

FIGS. 5A and 5B show an exemplary embodiment of a fixation assembly for a luminaire head.

### DESCRIPTION OF THE EMBODIMENTS

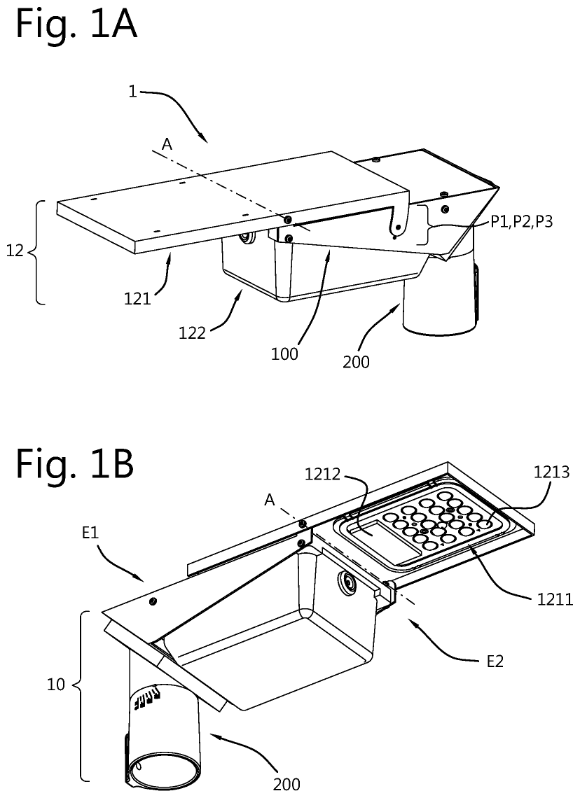

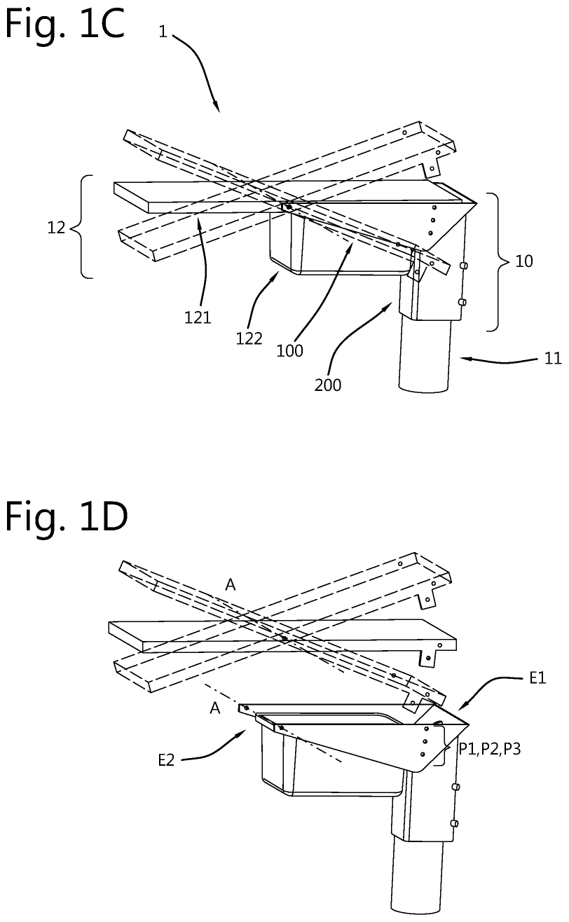

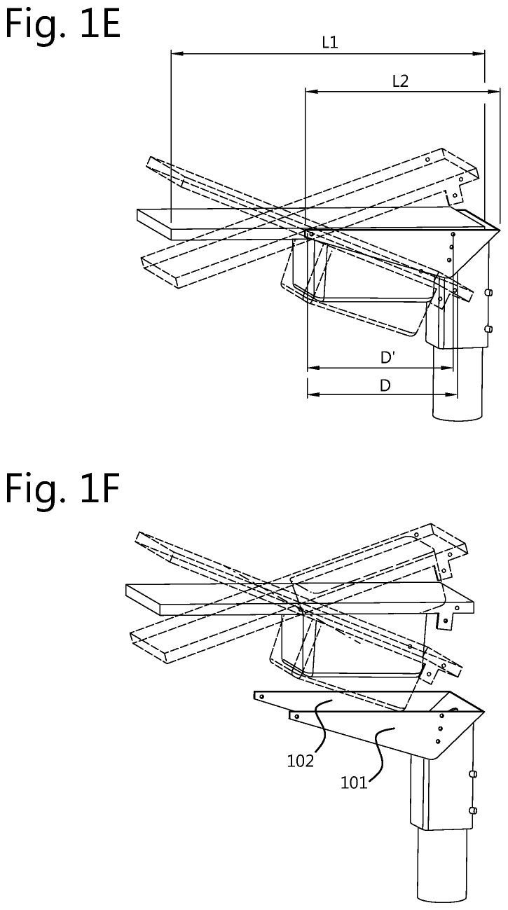

FIGS. 1A-1F are perspective views of an exemplary embodiment of a luminaire head.

The luminaire head 12 for a luminaire 1, preferably an outdoor luminaire 1, illustrated in FIGS. 1A-1F comprises a light module 121 provided with a light source 1211, a gear module 122 provided with a light source driving means, and a fixation assembly 10 configured to connect the luminaire head 12 to a luminaire support, such as a luminaire pole 11, and to adjust an orientation of at least the light module 121. A first portion of the luminaire head 12 comprising at least the fixation assembly 10 extends over a distance of at least 25% of a length L1 (see FIG. 1E) of the luminaire head 12, and a second portion of the luminaire head 12 comprising at least the light module 121 is configured to be rotated with respect to said first portion around a rotation axis A (see FIGS. 1A, 1B, and 1D). The fixation assembly 10 is configured to fix the light module 121 in a plurality of fixing positions. Three fixing positions P1, P2, P3 are illustrated in the embodiment of FIGS. 1A-1F. However, it should be clear to the skilled person that the amount of fixing positions may vary in other embodiments. For example, in an embodiment only two fixing positions may be present. In another embodiment, four, five, or even more fixing positions may be provided.

The fixation assembly 10 may comprise a first fixation element 100 configured to be attached to the luminaire head 12 and a second fixation element 200 configured to receive and be attached to the luminaire pole 11 and to cooperate with the first fixation element 100. The second fixation element 200 may play the role of an adaptor for the luminaire pole 11, as the second fixation element 200 may enable the connection of luminaire poles 11 having different dimensions, e.g. different diameters, to the luminaire head 12.

The light source 1211 may comprise a support 1212, such as a PCB, on which a plurality of light emitting diodes 1213 (LEDs) may be mounted. The LEDs 1213 may be arranged in an array of multiple columns and rows. The luminaire head 12 may be provided with a heat sink (not shown) including a plurality of cooling fins. One or more optical elements may be associated with the light source 1211. The one or more optical elements may comprise a plurality of lens elements associated with the plurality of LEDs, e.g. grouped in a lens plate (not shown). The luminaire head 12, in particular the light module 121, may further comprise a transparent or translucent portion facing the light source 1211. Optionally, a color filter may be arranged between the light source 1211 and the transparent or translucent portion. For example, the color filter may be a sheet arranged above the transparent or translucent portion. Preferably, the color filter may be accessible by opening the luminaire head 12, in particular the light module 121. The gear module 122 may comprise any one or more of the following: a light source dimming means, surge protection circuitry, electrostatic discharge (ESD) protection circuitry, connecting means, a fuse, a metering circuitry, a driving and/or control circuitry for any electrical components of the luminaire head 12. Optionally, a flux exhauster may be arranged at a side of the luminaire head 12, around the light source 1211.

The luminaire head 12 may comprise a housing wherein the light source 1211, the electrical/electronic components, and optionally the heat sink and the flux exhauster may be arranged. The transparent or translucent portion facing the light source 1211 may be part of the housing, in particular of the light module 121. Also, the housing may comprise an upper cover configured to cover and protect the components of the luminaire head 12 inside the housing. Preferably, the transparent or translucent portion and the upper cover form a sealed housing. In some embodiments, the luminaire head 12 can have an overall round shape, i.e., any one or more of the components of the luminaire head 12 may have a round shape. In other embodiments, such as in the embodiment of FIGS. 1A-1F, the luminaire head 12 may have an overall polygonal shape, such as a square or rectangular shape. Thus, any one or more of the components of the luminaire head 12 may have a polygonal shape. Also mixed shapes are possible.

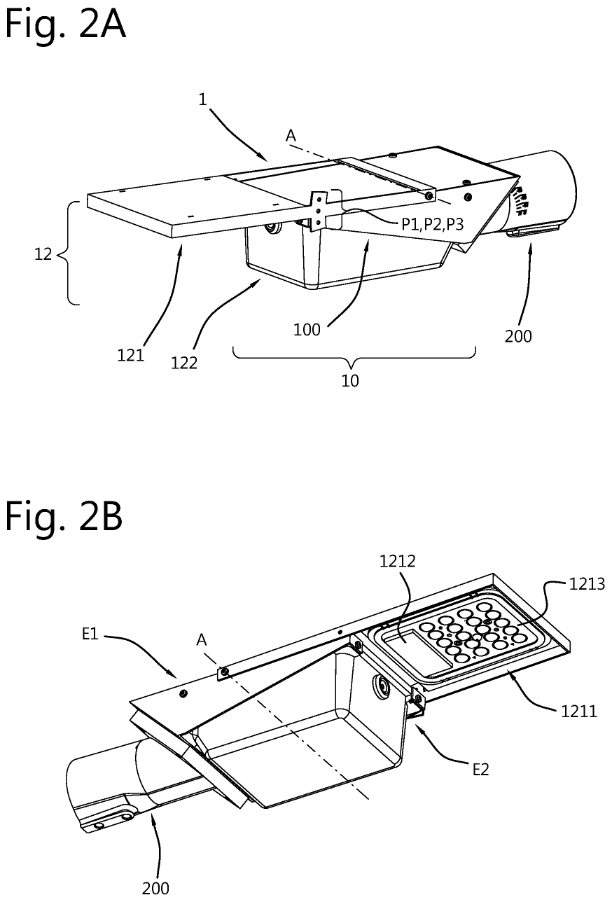

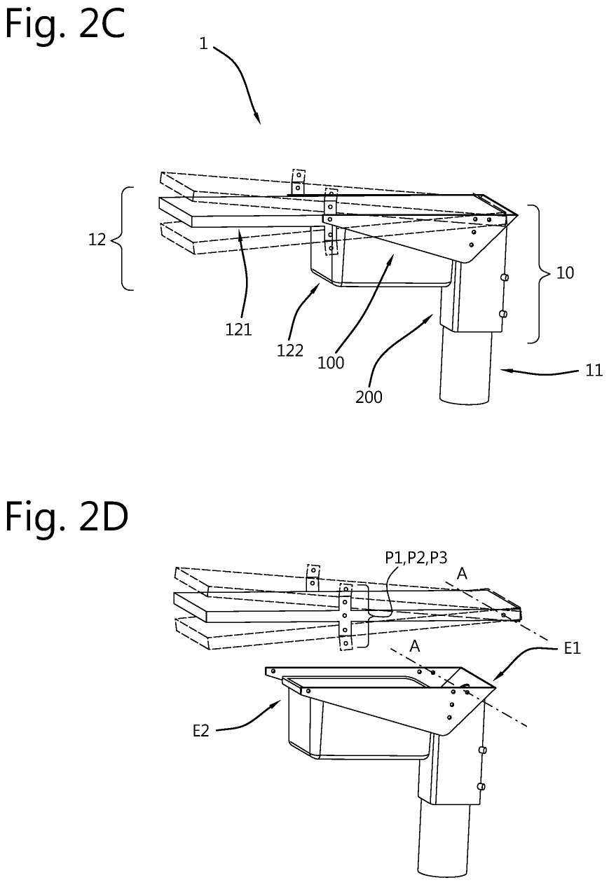

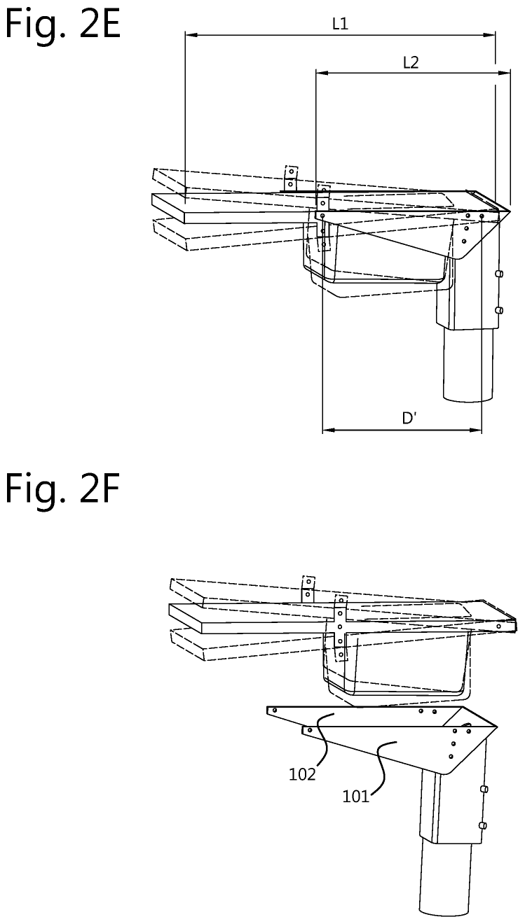

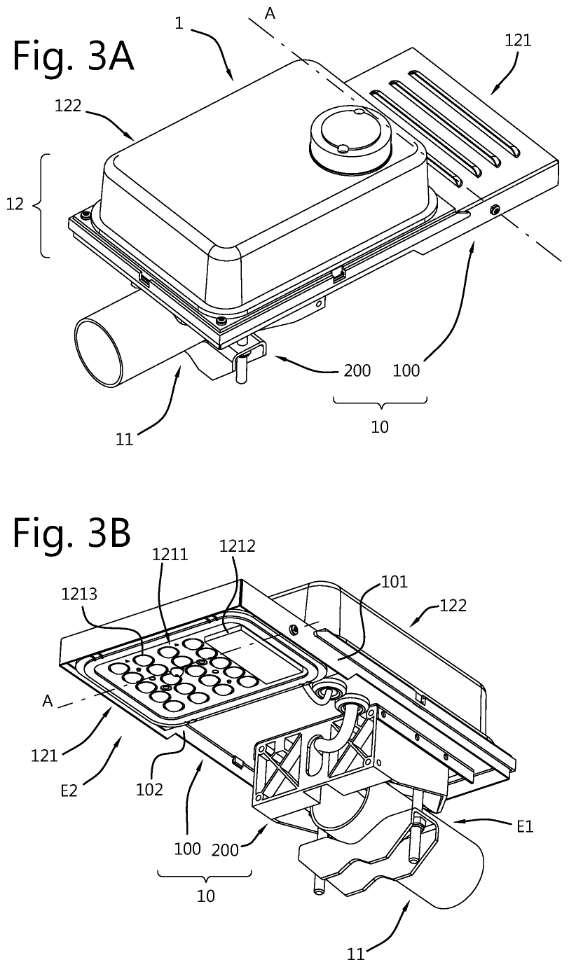

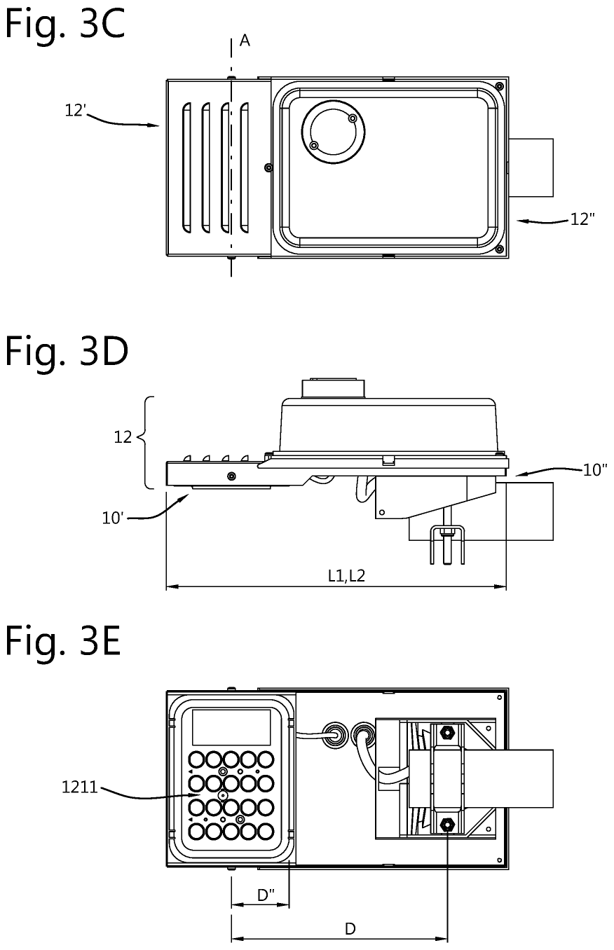

As illustrated in FIGS. 1A-1F, the fixation assembly 10 may have a first end E1 nearest to the luminaire pole 11 and a second end E2 opposite said first end E1 (see FIGS. 1B and 1D). The plurality of fixing positions P1, P2, P3 may be arranged at said first end E1, and the rotation axis A may be arranged at said second end E2. In other embodiments, such as in the embodiment of FIGS. 2A-2F, the plurality of fixing positions may be arranged at said second end, and the rotation axis may be arranged at said first end. As illustrated in FIG. 1E, a distance D between the rotation axis A and the luminaire pole 11 may be at least 25% of the length L1 of the luminaire head 12, preferably at least 40% of said length L1. In addition, as illustrated in FIG. 1E a distance D′ between the rotation axis A and the plurality of fixing positions P1, P2, P3 may be at least 25% of the length L1 of the luminaire head 12, preferably at least 40% of said length L1. Also, a length L2 of the fixation assembly 10 may be at most 75% of the length L1 of the luminaire head 12. In other embodiments, such as in the embodiment of FIGS. 3A-3E, the length of the fixation assembly may be substantially equal to the length of the luminaire head.

As illustrated in FIGS. 1C-1F, the rotation axis A and the plurality of fixing positions P1, P2, P3 may be configured to adjust a position of at least the light module 121 relative to the fixation assembly 10 over an angle of 15°, preferably over an angle of 30°. Two adjacent positions P1, P2 or P2, P3 of the plurality of fixing positions P1, P2, P3 may be configured to adjust a position of at least the light module 121 relative to the fixation assembly 10 over an angle between 2° and 15°. For example, the three fixing positions P1, P2, P3 may correspond to angular orientations of the light module 121 relative to the fixation assembly 10 ranging from −15° to +15° by steps of 15°. In another example, if more than three fixing positions are provided, e.g. seven fixing positions, the seven fixing positions may correspond to angular orientations of the light module 121 relative to the fixation assembly 10 ranging from −15° to +15° by steps of 5°. Accordingly, the outer side of the fixation assembly 10 may be provided with visual indications of the possible angular orientations of the light module 121 relative to the fixation assembly 10.

The first portion of the luminaire head 12 illustrated in FIGS. 1C and 1D may correspond to the fixation assembly 10 and the gear module 122. The gear module 122 may be configured to be attached to the fixation assembly 10 in a fixed position, and only the light module 121 may be configured to be rotated with respect to the fixation assembly 10 and the gear module 122. The light module 121 may delimit a first sealed compartment and the gear module 122 may delimit a second sealed compartment. Alternatively, the first portion of the luminaire head 12 illustrated in FIGS. 1E and 1F may correspond to the fixation assembly 10. The gear module 122 may be configured to be attached to the light module 121 in a fixed position, and the light module 121 and the gear module 122 may be configured to be rotated with respect to the fixation assembly 10. The light module 121 and the gear module 122 may delimit together a single sealed compartment.

As illustrated in FIGS. 1A-1F, the light module 121 may comprise a rotatable support comprising a front portion and a rear portion. The light source 1211 may be arranged in the front portion (see FIG. 1B), and the rear portion may be provided with at least one fixation bracket (not shown) arranged between the fixation assembly 10 and one side of the gear module 122 and configured to be fixed to the fixation assembly 10. Preferably, the rear portion may be provided with two fixation brackets arranged between the fixation assembly 10 and either side of the gear module 122 and configured to be fixed to the fixation assembly 10. Said at least one fixation bracket may be advantageous provided to the luminaire head 12 of FIGS. 1C and 1D, wherein the light module 121 is configured to be rotated with respect to the fixation assembly 10 and the gear module 122, the light module 121 delimiting a first sealed compartment and the gear module 122 delimiting a second sealed compartment. Alternatively, a minimal distance (not shown) between the fixed gear module 122 and the orientable light module 121 may be provided, so that the rotation movement of the light module 121 is not hindered by the presence of the fixed gear module 122. Thus, the rear portion of the rotatable support may be provided with a cover configured to cover the gear module 122 without hindering the rotation movement of the light module 121.

By contrast, as in the luminaire head 12 of FIGS. 1E and 1F, if both the light module 121 and the gear module 122 are orientable with respect to the fixation assembly 10, the rotation movement of the light module 121 would not be hindered by the presence of the gear module 122, since both modules 121, 122 are attached to each other and rotate together. Thus, the rear portion of the rotatable support may be provided with a cover configured to cover the gear module 122 without hindering the rotation movement of the light module 121. In this case, the light module 121 and the gear module 122 may delimit together a single sealed compartment.

The fixation assembly 10 may comprise two side wings 101, 102 (see FIG. 1F), each intersecting the rotation axis A. At least the light module 121 may be configured to be fixed to the two side wings 101, 102 in the plurality of fixing positions P1, P2, P3 and the gear module 122 may be at least partially arranged between the two side wings 101, 102. In the embodiment of FIGS. 1C and 1D, only the light module 121 may be configured to be fixed to the two side wings 101, 102 in the plurality of fixing positions P1, P2, P3. Alternatively, in the embodiment of FIGS. 1E and 1F, the light module 121 and the gear module 122 may be configured to be fixed to the two side wings 101, 102 in the plurality of fixing positions P1, P2, P3. The light module 121 may be rotated with respect to the fixation assembly 10 around the rotation axis A by means of a bolt with a head and an associated nut. The bolt may pass through the two side wings 101, 102 and through two opposite sides of the light module 121. Alternatively, the light module 121 may be rotated with respect to the fixation assembly 10 around the rotation axis A by means of two screws, each passing through one of the two side wings 101, 102 and through one of two opposite sides of the light module 121. In addition, the light module 121 may be fixed to the fixation assembly 10 in the plurality of fixing positions P1, P2, P3 by means of two screws, each passing through one of the two side wings 101, 102 and through one of two opposite sides of the light module 121.

FIGS. 2A-2F are perspective views of another exemplary embodiment of a luminaire head.

As in the embodiment of FIGS. 1A-1F, the luminaire head 12 for a luminaire 1, preferably an outdoor luminaire 1, illustrated in FIGS. 2A-2F comprises a light module 121 provided with a light source 1211, a gear module 122 provided with a light source driving means, and a fixation assembly 10 configured to connect the luminaire head 12 to a luminaire support 11, such as a luminaire pole 11, and to adjust an orientation of at least the light module 121. A first portion of the luminaire head 12 comprising at least the fixation assembly 10 extends over a distance of at least 25% of a length L1 (see FIG. 2E) of the luminaire head 12, and a second portion of the luminaire head 12 comprising at least the light module 121 is configured to be rotated with respect to said first portion around a rotation axis A (see FIGS. 2A, 2B, and 2D). The fixation assembly is configured to fix the light module 121 in a plurality of fixing positions. Three fixing positions P1, P2, P3 are illustrated in the embodiment of FIG. 2A, and five fixing positions are illustrated in the embodiment of FIGS. 2C-2F. However, it should be clear to the skilled person that the amount of fixing positions may vary in other embodiments.

As in the embodiment of FIGS. 1A-1F, the fixation assembly 10 may comprise a first fixation element 100 configured to be attached to the luminaire head 12 and a second fixation element 200 configured to receive and be attached to the luminaire pole 11 and to cooperate with the first fixation element 100. The second fixation element 200 may play the role of an adaptor for the luminaire pole 11, as the second fixation element 200 may enable the connection of luminaire poles 11 having different dimensions, e.g. different diameters, to the luminaire head 12.

The light source 1211 may comprise a support 1212, such as a PCB, on which a plurality of LEDs 1213 may be mounted. The gear module 122 may comprise any one or more of the following: a light source dimming means, surge protection circuitry, ESD protection circuitry, connecting means, a fuse, a metering circuitry, a driving and/or control circuitry for any electrical components of the luminaire head 12.

As illustrated in FIGS. 2A-2F, the fixation assembly 10 may have a first end E1 nearest to the luminaire pole 11 and a second end E2 opposite said first end E1 (see FIGS. 2B and 2D). In contrast to the embodiment of FIGS. 1A-1F, the plurality of fixing positions P1, P2, P3 may be arranged at said second end E2, and the rotation axis A may be arranged at said first end E1. As illustrated in FIG. 2E, a distance D′ between the rotation axis A and the plurality of fixing positions P1, P2, P3 may be at least 25% of the length L1 of the luminaire head 12, preferably at least 40% of said length L1. Also, a length L2 of the fixation assembly 10 may be at most 75% of the length L1 of the luminaire head 12, as in the embodiment of FIGS. 1A-1F.

As illustrated in FIGS. 2C-2F, the rotation axis A and the plurality of fixing positions P1, P2, P3 may be configured to adjust a position of at least the light module 121 relative to the fixation assembly 10 over an angle of 15°, preferably over an angle of 30°. Two adjacent positions P1, P2 or P2, P3 of the plurality of fixing positions P1, P2, P3 may be configured to adjust a position of at least the light module 121 relative to the fixation assembly 10 over an angle between 2° and 15°. For example, the three fixing positions P1, P2, P3 may correspond to angular orientations of the light module 121 relative to the fixation assembly 10 ranging from −15° to +15° by steps of 15°. In another example, if more than three fixing positions are provided, e.g. seven fixing positions, the seven fixing positions may correspond to angular orientations of the light module 121 relative to the fixation assembly 10 ranging from −15° to +15° by steps of 5°. Accordingly, the outer side of the fixation assembly 10 may be provided with visual indications of the possible angular orientations of the light module 121 relative to the fixation assembly 10.

The first portion of the luminaire head 12 illustrated in FIGS. 2C and 2D may correspond to the fixation assembly 10 and the gear module 122. The gear module 122 may be configured to be attached to the fixation assembly 10 in a fixed position, and only the light module 121 may be configured to be rotated with respect to the fixation assembly 10 and the gear module 122. The light module 121 may delimit a first sealed compartment and the gear module 122 may delimit a second sealed compartment. Alternatively, the first portion of the luminaire head 12 illustrated in FIGS. 2E and 2F may correspond to the fixation assembly 10. The gear module 122 may be configured to be attached to the light module 121 in a fixed position, and the light module 121 and the gear module 122 may be configured to be rotated with respect to the fixation assembly 10. The light module 121 and the gear module 122 may delimit together a single sealed compartment.

As illustrated in FIGS. 2A-2F, the light module 121 may comprise a rotatable support comprising a front portion and a rear portion. The light source 1211 may be arranged in the front portion (see FIG. 2B), and the rear portion may be provided with at least one fixation bracket (not shown) arranged between the fixation assembly 10 and one side of the gear module 122 and configured to be fixed to the fixation assembly 10. Preferably, the rear portion may be provided with two fixation brackets arranged between the fixation assembly 10 and either side of the gear module 122 and configured to be fixed to the fixation assembly 10. As in the embodiment of FIGS. 1C and 1D, said at least one fixation bracket may be advantageous provided to the luminaire head 12 of FIGS. 2C and 2D. Alternatively, a minimal distance (not shown) between the fixed gear module 122 and the orientable light module 121 may be provided, so that the rotation movement of the light module 121 is not hindered by the presence of the fixed gear module 122. Thus, the rear portion of the rotatable support may be provided with a cover configured to cover the gear module 122 without hindering the rotation movement of the light module 121.

By contrast, if both the light module 121 and the gear module 122 are orientable with respect to the fixation assembly 10, the rear portion of the rotatable support may be provided with a cover configured to cover the gear module 122 without hindering the rotation movement of the light module 121. As in the embodiment of FIGS. 1E and 1F, said cover may be provided to the luminaire head 12 of FIGS. 2E and 2F. In this case, the light module 121 and the gear module 122 may delimit together a single sealed compartment.

The fixation assembly 10 may comprise two side wings 101, 102 (see FIG. 2F), each intersecting the rotation axis A. At least the light module 121 may be configured to be fixed to the two side wings 101, 102 in the plurality of fixing positions P1, P2, P3 and the gear module 122 may be at least partially arranged between the two side wings 101, 102. In the embodiment of FIGS. 2C and 2D, only the light module 121 may be configured to be fixed to the two side wings 101, 102 in the plurality of fixing positions P1, P2, P3. Alternatively, in the embodiment of FIGS. 2E and 2F, the light module 121 and the gear module 122 may be configured to be fixed to the two side wings 101, 102 in the plurality of fixing positions P1, P2, P3. As in the embodiment of FIGS. 1A-1F, the light module 121 may be rotated with respect to the fixation assembly 10 around the rotation axis A by means of a bolt with a head and an associated nut. The bolt may pass through the two side wings 101, 102 and through two opposite sides of the light module 121. Alternatively, the light module 121 may be rotated with respect to the fixation assembly 10 around the rotation axis A by means of two screws, each passing through one of the two side wings 101, 102 and through one of two opposite sides of the light module 121. In addition, the light module 121 may be fixed to the fixation assembly 10 in the plurality of fixing positions P1, P2, P3 by means of two screws, each passing through one of the two side wings 101, 102 and through one of two opposite sides of the light module 121.

FIGS. 3A-3E are perspective views of yet another exemplary embodiment of a luminaire head.

The luminaire head 12 for a luminaire 1, preferably an outdoor luminaire, illustrated in FIGS. 3A-3E comprises a light module 121 provided with a light source 1211, a gear module 122 provided with a light source driving means, and a fixation assembly 10 configured to connect the luminaire head 12 to a luminaire support, such as a luminaire pole 11, and to adjust an orientation of only the light module 121. A first portion of the luminaire head 12 comprising at least the fixation assembly extends over a distance of at least 25% of a length L1 (see FIG. 3D) of the luminaire head 12, and a second portion of the luminaire head 12 comprising only the light module 121 is configured to be rotated with respect to said first portion around a rotation axis A. The fixation assembly 10 is configured to fix the light module 121 in a plurality of fixing positions (not shown in FIGS. 3A-3E).

As in the embodiments of FIGS. 1A-1F and 2A-2F, the fixation assembly 10 may comprise a first fixation element 100 configured to be attached to the luminaire head 12 and a second fixation element 200 configured to receive and be attached to the luminaire pole 11 and to cooperate with the first fixation element 100. The second fixation element 200 may play the role of an adaptor for the luminaire pole 11, as the second fixation element 200 may enable the connection of luminaire poles 11 having different dimensions, e.g. different diameters, to the luminaire head 12.

The light source 1211 may comprise a support 1212, such as a PCB, on which a plurality of LEDs 1213 may be mounted. The gear module 122 may comprise any one or more of the following: a light source dimming means, surge protection circuitry, ESD protection circuitry, connecting means, a fuse, a metering circuitry, a driving and/or control circuitry for any electrical components of the luminaire head 12.

As illustrated in FIGS. 3A-3E, the fixation assembly 10 may have a first end E1 nearest to the luminaire pole 11 and a second end E2 opposite said first end E1 (see FIG. 3B). In the embodiments of FIGS. 1A-1F and 2A-2F, one of the rotation axis A and the plurality of fixing positions P1, P2, P3 may be arranged at said first end E1 and the other one thereof may be arranged at said second end E2. By contrast, in the embodiment of FIGS. 3A-3E the plurality of fixing positions (not shown) and the rotation axis A may both be arranged at said second end E2, i.e., at a distance D″ from each other that is significantly smaller than the length L2 of the fixation assembly 10. As illustrated in FIG. 3E the distance D″ between the rotation axis A and the plurality of fixing positions may be lower than 25% of the length L1 of the luminaire head 12, contrary to the embodiments of FIGS. 1A-1F and 2A-2F. Also, in contrast to the embodiments of FIGS. 1A-1F and 2A-2F, in the embodiment of FIGS. 3A-3E a length L2 of the fixation assembly 10 may be substantially equal to the length L1 of the luminaire head 12 (see FIG. 3D).

Although not shown in FIGS. 3A-3E, the rotation axis A and the plurality of fixing positions may be configured to adjust a position of the light module 121 relative to the fixation assembly 10 over an angle of 15°, preferably over an angle of 30°. Two adjacent positions of the plurality of fixing positions may be configured to adjust a position of the light module 121 relative to the fixation assembly 10 over an angle between 2° and 15°. For example, the three fixing positions P1, P2, P3 may correspond to angular orientations of the light module 121 relative to the fixation assembly 10 ranging from −15° to +15° by steps of 15°. In another example, if more than three fixing positions are provided, e.g. seven fixing positions, the seven fixing positions may correspond to angular orientations of the light module 121 relative to the fixation assembly 10 ranging from −15° to +15° by steps of 5°. Accordingly, the outer side of the fixation assembly 10 may be provided with visual indications of the possible angular orientations of the light module 121 relative to the fixation assembly 10.

The first portion of the luminaire head 12 illustrated in FIGS. 3A-3E corresponds to the fixation assembly 10 and the gear module 122. The gear module 122 may be configured to be attached to the fixation assembly 10 in a fixed position, and the light module 121 may be configured to be rotated with respect to the fixation assembly 10 and the gear module 122. The light module 121 may delimit a first sealed compartment and the gear module 122 may delimit a second sealed compartment. In contrast to the embodiments of FIGS. 1A-1F and 2A-2F wherein the gear module 122 is arranged in a lower part of the luminaire head 12, below the light module 121 when seen in a horizontal plane, the gear module 122 of the embodiment of FIGS. 3A-3E is arranged in an upper part of the luminaire head 12, above the light module 121 when seen in said horizontal plane.

As illustrated in FIGS. 3A-3E, the light module 121 may comprise a rotatable support at a front side 12′ of the luminaire head 12 whereon the light source 1211 is arranged, and the gear module 122 may comprise a fixed support at a rear side 12″ of the luminaire head 12 whereon the light source driving means is arranged. Seen in plane parallel to said rotatable support and to said fixed support, there is no overlap between the rotatable support and the fixed support (see FIGS. 3C-3E). The fixation assembly 10 may comprise a front portion 10′ at the front side 12′ of the luminaire head 12 and configured to receive the light module 121, and a rear portion 10″ at the rear side 12″ of the luminaire head 12 and configured to receive the gear module 122 (see FIG. 3D).

The fixation assembly 10 may comprise two side wings 101, 102 (see FIG. 3B), each intersecting the rotation axis A. In the embodiment of FIGS. 3A-3E, only the light module 121 may be configured to be fixed to the two side wings 101, 102 in the plurality of fixing positions P1, P2, P3 and the gear module 122 may be at least partially arranged between the two side wings 101, 102. As in the embodiments of FIGS. 1A-1F and FIGS. 2A-2F, the light module 121 may be rotated with respect to the fixation assembly 10 around the rotation axis A by means of a bolt with a head and an associated nut. The bolt may pass through the two side wings 101, 102 and through two opposite sides of the light module 121. Alternatively, the light module 121 may be rotated with respect to the fixation assembly 10 around the rotation axis A by means of two screws, each passing through one of the two side wings 101, 102 and through one of two opposite sides of the light module 121. In addition, the light module 121 may be fixed to the fixation assembly 10 in the plurality of fixing positions by means of two screws, each passing through one of the two side wings 101, 102 and through one of two opposite sides of the light module 121.

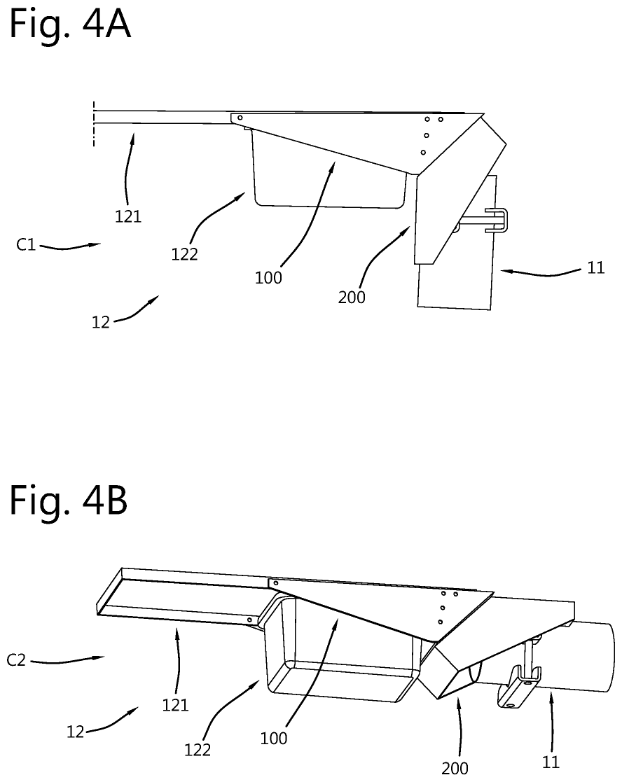

FIGS. 4A and 4B show two different exemplary embodiments of a luminaire head according to two different fixation configurations to a luminaire support.

As illustrated in FIGS. 4A and 4B, the fixation assembly 10 may comprise a first fixation element 100 configured to be attached to the luminaire head 12 and a second fixation element 200 configured to receive and be attached to the luminaire pole 11 and to cooperate with the first fixation element 100. The second fixation element 200 may play the role of an adaptor for the luminaire pole 11, as the second fixation element 200 may enable the connection of luminaire poles 11 having different dimensions, e.g. different diameters, to the luminaire head 12. The second fixation element 200 may be configured to be fastened to the first fixation element 100 in a first configuration C1 (see FIG. 4A) and in a second configuration C2 (see FIG. 4B). As illustrated in FIG. 4A, the first fixation element 100 and the second fixation element 200 may be substantially perpendicular in the first configuration C1. Alternatively, as illustrated in FIG. 4B the first fixation element 100 and the second fixation element 200 may be substantially parallel in the second configuration C2. The first configuration C1 may be referred to as “post-top” configuration of the luminaire head 12, whereas the second configuration C2 may be referred to as “side-entry” configuration of the luminaire head 12.

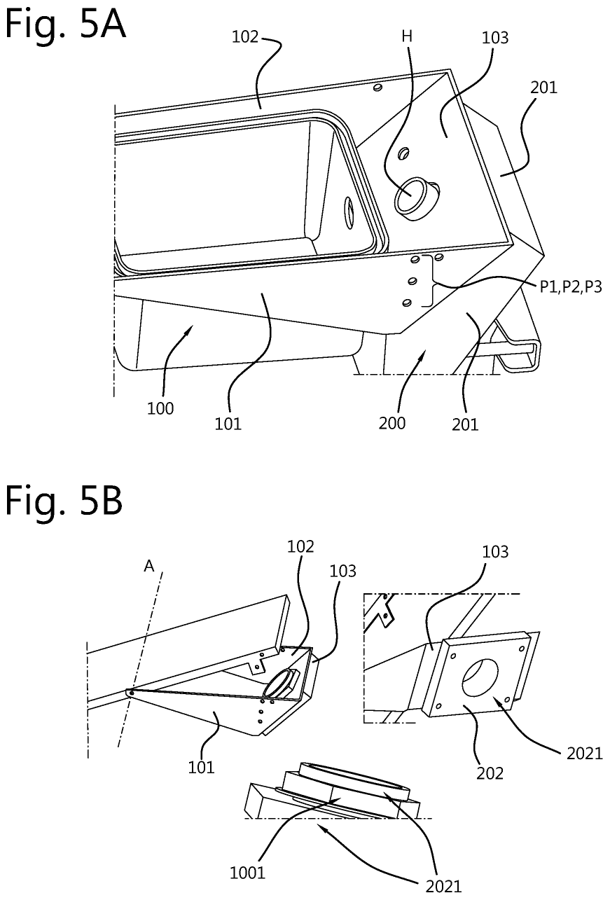

FIGS. 5A and 5B show an exemplary embodiment of a fixation assembly for a luminaire head.

The fixation assembly 10 may comprise two side wings 101, 102, each intersecting the rotation axis A (see FIG. 5B). The light module 121 may be rotated with respect to the fixation assembly around the rotation axis A by means of a bolt with a head and an associated nut. The bolt passes through the two side wings 101, 102 and through two opposite sides of the light module 121. Alternatively, the light module 121 may be rotated with respect to the fixation assembly 10 around the rotation axis A by means of two screws, each passing through one of the two side wings 101, 102 and through one of two opposite sides of the light module 121. In addition, the light module 121 may be fixed to the fixation assembly 10 in the plurality of fixing positions P1, P2, P3 by means of two screws, each passing through one of the two side wings 101, 102 and through one of two opposite sides of the light module 121. The embodiment of FIGS. 5A and 5B may correspond to the embodiment of FIGS. 1E and 1F and FIGS. 2E and 2F, wherein the light module 121 and the gear module 122 may be configured to be fixed to the two side wings 101, 102 in the plurality of fixing positions P1, P2, P3 and the gear module 122 may be at least partially arranged between the two side wings 101, 102. Alternatively, the embodiment of FIGS. 5A and 5B may correspond to the embodiments of FIGS. 1C and 1D, FIGS. 2C and 2D, and FIGS. 3A-3E, wherein only the light module 121 may be configured to be fixed to the two side wings 101, 102 in the plurality of fixing positions P1, P2, P3 and the gear module 122 may be at least partially arranged between the two side wings 101, 102.

As illustrated in FIGS. 5A and 5B, the fixation assembly 10 may comprise a first fixation element 100 configured to be attached to the luminaire head and a second fixation element 200 configured to receive and be attached to the luminaire pole and to cooperate with the first fixation element 100. The first fixation element 100 may comprise the two side wings 101, 102 and an inclined base wall 103 connecting the two side wings 101, 102. The second fixation element 200 may comprise a tubular wall 201 and an inclined base wall 202 configured to match the inclined base wall 103 of the first element fixation 100 in said first configuration C1 (see FIG. 4A) and second configuration C2 (see FIG. 4B). Preferably, the inclined base wall 103 of the first fixation element 100 may be inclined at an angle of 45° with respect to a plane perpendicular to the two side wings 101, 102.

As illustrated in FIG. 5B, the inclined base wall 202 of the second fixation element 200 may be provided with a threaded portion 2021 protruding through the inclined base wall 103 of the first fixation element 100, and the inclined base wall 103 of the first fixation element 100 may be provided with a nut 1001 matching the threaded portion 2021. Said threaded portion 2021 may be provided with a hole H configured to receive a cable extending between the luminaire support and the luminaire head 12.

Common to all embodiments described above in relation to FIGS. 1A-5B, there is provided a fixation assembly 10 for use in the luminaire head 12 of any one of the above embodiments, wherein the fixation assembly 10 is configured to connect the luminaire head 12 to a luminaire support, such as the luminaire pole 11 of any one of the above embodiments, and to adjust the orientation of at least the light module 121. A first portion of the luminaire head 12 comprising at least the fixation assembly 10 extends over a distance of at least 25% of a length L1 of the luminaire head 12, and a second portion of the luminaire head 12 comprising at least the light module 121 is configured to be rotated with respect to said first portion around a rotation axis A. The fixation assembly 10 is configured to fix the light module 121 in a plurality of fixing positions P1, P2, P3.

Common to all embodiments described above in relation to FIGS. 1A-5B, there is provided a method for adjusting an orientation of a luminaire head 12, such as the luminaire head 12 of any one of the above embodiments, connected to a luminaire support, such as the luminaire pole 11 of any one of the above embodiments, with the above fixation assembly 10. Said luminaire head 12 comprises a light module 121 provided with a light source 1211 and a gear module 122 provided with a light source driving means. Said method comprises the following steps: rotating at least the light module 121 relative to the fixation assembly 10 around the rotation axis A in order to control the orientation of at least the light module 121, and fixing the light module 121 to the fixation assembly 10 in the plurality of fixing positions P1, P2, P3.

Whilst the principles of the invention have been set out above in connection with specific embodiments, it is to be understood that this description is merely made by way of example and not as a limitation of the scope of protection which is determined by the appended claims.

1. A luminaire head for a luminaire, preferably an outdoor luminaire, said luminaire head comprising:
a light module provided with a light source;
a gear module provided with a light source driving means; and
a fixation assembly configured to connect the luminaire head to a luminaire support, such as a luminaire pole, and to adjust an orientation of at least the light module;
wherein a first portion of the luminaire head comprising at least the fixation assembly extends over a distance of at least 25% of a length of the luminaire head, and a second portion of the luminaire head comprising at least the light module is configured to be rotated with respect to said first portion around a rotation axis;
wherein the fixation assembly is configured to fix the light module in a plurality of fixing positions.

2. The luminaire head of claim 1, wherein a distance between the rotation axis and the luminaire support is at least 25% of the length of the luminaire head, preferably at least 40% of said length.

3. The luminaire head of claim 1, wherein a distance between the rotation axis and the plurality of fixing positions is at least 25% of the length of the luminaire head, preferably at least 40% of said length.

4. The luminaire head of claim 1 wherein a length of the fixation assembly is at most 75% of the length of the luminaire head.

5. The luminaire head of claim 1, wherein a length of the fixation assembly is substantially equal to the length of the luminaire head.

6. The luminaire head of claim 1 wherein the fixation assembly has a first end nearest to the luminaire support and a second end opposite said first end;
wherein one of the rotation axis and the plurality of fixing positions is arranged at said first end, and the other one of the rotation axis and the plurality of fixing positions is arranged at said second end.

7. The luminaire head of claim 1 wherein the rotation axis and the plurality of fixing positions are configured to adjust a position of at least the light module relative to the fixation assembly over an angle of 15°, preferably over an angle of 30°.

8. The luminaire head of claim 1 wherein two adjacent positions of the plurality of fixing positions are configured to adjust a position of at least the light module relative to the fixation assembly over an angle between 2° and 15°.

9. The luminaire head of claim 1 wherein the first portion of the luminaire head corresponds to the fixation assembly and the gear module; wherein the gear module is configured to be attached to the fixation assembly in a fixed position, and the light module is configured to be rotated with respect to the fixation assembly and the gear module; wherein preferably the light module delimits a first sealed compartment and the gear module delimits a second sealed compartment.

10. (canceled)

11. The luminaire head of claim 1, wherein the first portion of the luminaire head corresponds to the fixation assembly; wherein the gear module is configured to be attached to the light module in a fixed position, and the light module and the gear module are configured to be rotated with respect to the fixation assembly; wherein preferably the light module and the gear module delimit together a single sealed compartment.

12. (canceled)

13. The luminaire head of claim 1 wherein the light module comprises a rotatable support comprising a front portion and a rear portion;
wherein the light source is arranged in the front portion, and the rear portion is provided with at least one fixation bracket arranged between the fixation assembly and one side of the gear module and configured to be fixed to the fixation assembly, or with a cover configured to cover the gear module.

14. The luminaire head of claim 1, wherein the light module comprises a rotatable support at a front side of the luminaire head whereon the light source is arranged, and the gear module comprises a fixed support at a rear side of the luminaire head whereon the light source driving means is arranged;
wherein, seen in plane parallel to said rotatable support and to said fixed support, there is no overlap between the rotatable support and the fixed support;
wherein preferably the fixation assembly comprises a front portion at the front side of the luminaire head and configured to receive the light module, and a rear portion at the rear side of the luminaire head and configured to receive the gear module.

15. (canceled)

16. The luminaire head of claim 1 wherein the fixation assembly comprises two side wings, each intersecting the rotation axis;
wherein at least the light module is configured to be fixed to the two side wings in the plurality of fixing positions and the gear module is at least partially arranged between the two side wings.

17. The luminaire head of previous claim 1 wherein the fixation assembly comprises a first fixation element configured to be attached to the luminaire head and a second fixation element configured to receive and be attached to the luminaire support and to cooperate with the first fixation element.

18. The luminaire head of claim 17, wherein the second fixation element is configured to be fastened to the first fixation element in a first configuration and in a second configuration;
wherein the first fixation element and the second fixation element are substantially perpendicular in the first configuration and substantially parallel in the second configuration.

19. The luminaire head of claim 18, wherein the first fixation element comprises two side wings and an inclined base wall connecting the two side wings, and the second fixation element comprises a tubular wall and an inclined base wall configured to match the inclined base wall of the first element fixation in said first configuration and second configuration.

20. The luminaire head of claim 19, wherein the inclined base wall of the first fixation element is inclined at an angle of 45° with respect to a plane perpendicular to the two side wings; and/or
wherein the inclined base wall of the second fixation element is provided with a threaded portion protruding through the inclined base wall of the first fixation element, and the inclined base wall of the first fixation element is provided with a nut matching the threaded portion, wherein preferably said threaded portion is provided with a hole configured to receive a cable extending between the luminaire support and the luminaire head.

21. (canceled)

22. (canceled)

23. The luminaire head of claim 1 wherein the light source comprises a support, such as a PCB, on which a plurality of light emitting diodes is mounted; and/or
wherein the gear module comprises any one or more of the following: a light source dimming means, surge protection circuitry, electrostatic discharge protection circuitry, connecting means, a fuse, a metering circuitry, a driving and/or control circuitry for any electrical components of the luminaire head.

24. (canceled)

25. A fixation assembly for use in the luminaire head of claim 1, wherein the fixation assembly is configured to connect the luminaire head to the luminaire support and to adjust the orientation of at least the light module;
wherein a first portion of the luminaire head comprising at least the fixation assembly extends over a distance of at least 25% of a length of the luminaire head, and a second portion of the luminaire head comprising at least the light module is configured to be rotated with respect to said first portion around a rotation axis;
wherein the fixation assembly is configured to fix the light module in a plurality of fixing positions.

26. A method for adjusting an orientation of a luminaire head connected to a luminaire support, such as a luminaire pole, with the fixation assembly of claim 25, said luminaire head comprising a light module provided with a light source and a gear module provided with a light source driving means, said method comprising rotating at least the light module relative to the fixation assembly around the rotation axis in order to control the orientation of at least the light module and fixing the light module to the fixation assembly in a plurality of fixing positions.
